(19) United States
(12) Patent Application Publication
(10) Pub. No.: US 2006/0106870 A1
(43) Pub. Date: May 18, 2006

(54) Data compression using a nested hierarchy of fixed phrase length dictionaries

(75) Inventors: Peter A. Franaszek, Mount Kisco, NY (US); Luis Alfonso Lastras Montano, Cortlandt Manor, NY (US); John T. Robinson, Yorktown Heights, NY (US)

Correspondence Address: F. CHAU & ASSOCIATES, LLC, 130 WOODBURY ROAD, WOODBURY, NY, 11797, US

(73) Assignee: International Business Machines Corporation

(21) Appl. No.: 10/989,690

(22) Filed: Nov. 16, 2004

(51) Int. Cl. G06F 17/00; G06F 7/00

(52) U.S. Cl. 707/104.1

(57) ABSTRACT

Exemplary embodiments are described herein whereby blocks of data are losslessly compressed and decompressed using a nested hierarchy of fixed phrase length dictionaries. The dictionaries may be built using information related to the manner in which data is commonly organized in computer systems for convenient retrieval, processing, and storage. This results in low cost designs that give significant compression. Further, the methods can be implemented very efficiently in hardware.

### BACKGROUND OF THE INVENTION

1. Field of the Invention

The present invention relates to lossless data compression, and, more particularly, to very fast lossless compression and decompression of blocks of data utilizing minimal resources.

2. Description of the Related Art

Data compression is generally the process of removing redundancy within data. Eliminating such redundancy may reduce the amount of storage required to store the data, and the bandwidth and time necessary to transmit the data. Thus, data compression can result in improved system efficiency.

Lossless data compression involves a transformation of the representation of a data set so that it is possible to reproduce exactly the original data set by performing a decompression transformation. Lossless compression, as opposed to lossy compression, is necessary when an exact representation of the original data set is required, such as in a financial transaction or with executable code.

Previous work on fast hardware-based lossless compression includes the compressor/decompressor design (hereinafter referred to as the “first approach”) described in Tremaine et al., IBM Memory Expansion Technology (MXT), IBM Journal of Res. & Develop. 45, 2 (March 2001), pp. 271-285. The first approach gives excellent compression comparable to the well-known sequential LZ77 methods on 1024 byte blocks. The compression is accomplished by means of 4-way parallel compression using a shared dictionary. The first approach was implemented in hardware and detected matching phrases at byte granularity.

A problem with the first approach is that it requires a number of one-byte comparators on a chip that is on the order of the degree of parallelism multiplied by the block size, which is typically in bytes. For example, a system of the first approach that compresses 1024 byte blocks using four parallel encoders would require 4,080 (255*4*4) one byte comparators. In addition to these comparators, the chip also includes compression logic for matching phrase detection and merging compressed output streams. As implemented using current technologies, these one-byte comparators and additional compression logic can represent significant chip area, which can preclude the use of this approach in some applications in which the chip area available for compression is highly constrained.

Other work on or related to fast hardware lossless compression with reduced hardware complexity includes:

(1) Nunez et al., The X-MatchPRO 100 Mbytes/second FPGA-Based Lossless Data Compressor, Proceedings of Design, Automation and Test in Europe, DATE Conference 2000, pp. 139-142, March, 2000 (hereinafter referred to as the “second approach”); and

(2) Wilson et al., The Case for Compressed Caching in Virtual Memory Systems, Proceedings of the USENIX Annual Technical Conference, June 1999, pp. 6-11 (hereinafter referred to as the “third approach”).

In the second approach, only a single fixed size phrase (e.g., 4 bytes as described in the second approach) is used for matching purposes, and partial matches within this fixed length phrase are supported. The “move to front” dictionary employed in the second approach imposes additional hardware complexity as compared to simply using random access memories (“RAMs”) as dictionaries. In particular, as described in the second approach, a content addressable memory consisting of 64 4-byte entries is used, implying an immediate hardware cost of 64 4-byte comparators.

The third approach involves a special purpose method in which a dictionary consisting of the 16 most recently seen 4-byte words is used. The dictionary is managed as either a direct mapped cache (i.e, a RAM), or as a 4×4 set associative cache. Although the third approach would, if implemented in hardware, have very low cost, the fixed phrase length size (e.g., 4 bytes), together with the constraints on matching in only a small set of special cases (e.g., all-zeroes, match upper 22 bits, or match all 32 bits), results in match possibilities that may be overly restrictive.

### SUMMARY OF THE INVENTION

In one aspect of the present invention, a method for compressing a stream of symbols is provided. The method includes dividing the stream into fixed-length blocks; for each of the fixed-length blocks, searching entries in a plurality of dictionaries for fixed-length phrases obtained from the each of the fixed-length blocks; choosing one of a plurality of partitions of the each of the fixed-length blocks based on the results of the step of searching and on a specified plurality of allowed partitions, wherein the one of the plurality of partitions comprises a plurality of non-overlapping component phrases, and wherein a concatenation of the plurality of non-overlapping component phrases comprises the each of the fixed-length blocks; and for each of the non-overlapping component phrases, obtaining one of a pointer and a literal to represent the each of the non-overlapping component phrases.

In a second aspect of the present invention, a method for compressing a stream of symbols in parallel is provided. The method includes dividing the stream into collections of fixed-length blocks, wherein each item in the collections comprises one fixed-length block; for the each item, searching in parallel entries in a plurality of dictionaries for fixed-length phrases obtained from the each item; for the each item, choosing one of a plurality of partitions based on (a) the results of the step of searching and (b) on a specified plurality of allowed partitions, wherein the one of the plurality of partitions comprises a plurality of non-overlapping component phrases, and wherein a concatenation of the plurality of non-overlapping component phrases comprises the each item; and for the each item and for each component phrase of the one of the plurality of partitions, obtaining one of a pointer and a literal to represent the each component phrase.

In a third aspect of the present invention, a method for hierarchically aligning a stream of symbols in which the length of phrases of smaller length divide the length of phrases of longer length is provided. The method includes for a given length, the given length comprising each incrementally longer length starting from the smallest length, (a) maintaining separate dictionaries for different alignments associated with the given length; (b) counting the number of times a phrase is not found in each of the dictionaries and (c) choosing one of the different alignments based on the result of the step of counting.

In a fourth aspect of the present invention, a system comprising a hierarchical data structure, wherein the hierarchical data structure comprises a first dictionary and a second dictionary, wherein the first dictionary comprises at least one first phrase of a first fixed-length, wherein the second dictionary comprises at least one second phrase of a second fixed-length differing from the first phrase length, wherein each of the at least one first phrase and at least one second phrase is associated with a unique hash key, a method for compressing a block of data using the dictionary is provided. The method including (a) segmenting the block into first plurality of subblocks, wherein the size of each of the first plurality of subblocks is the first fixed-length; (b) segmenting the block into a second plurality of subblocks, wherein the size of each of the second plurality of subblocks is the second fixed-length; (c) querying the first dictionary for each of the first plurality of subblocks to find a at least one first match; (d) querying the second dictionary for each of the second plurality of subblocks to find at least one second match; (e) if at least one of the first match is found in the dictionary, encoding the first match using a first unique pointer associated with the at least one first match; and (f) if at least one of the second match is found in the dictionary, encoding the at least one second match using a second unique pointer associated with the at least one second match.

### BRIEF DESCRIPTION OF THE DRAWINGS

The invention may be understood by reference to the following description taken in conjunction with the accompanying drawings, in which like reference numerals identify like elements, and in which:

FIG. 1 depicts an exemplary control flow of an encoder, in accordance with one embodiment of the present invention;

FIG. 2 depicts also an exemplary control flow of the encoder of FIG. 1, in accordance with one embodiment of the present invention;

FIG. 3 depicts an exemplary outcome of the encoder of FIG. 1, in accordance with one embodiment of the present invention; and

FIG. 4 depicts an exemplary control flow of a decoder, in accordance with one embodiment of the present invention.

### DETAILED DESCRIPTION OF PREFERRED EMBODIMENTS

Illustrative embodiments of the invention are described below. In the interest of clarity, not all features of an actual implementation are described in this specification. It will be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

Exemplary embodiments are described herein whereby blocks of data are losslessly compressed and decompressed using a nested hierarchy of fixed phrase length dictionaries. The dictionaries may be built using information related to the manner in which data is commonly organized in computer systems for convenient retrieval, processing, and storage. This results in low-cost designs that give significant compression. Further, the embodiments can be implemented very efficiently in hardware.

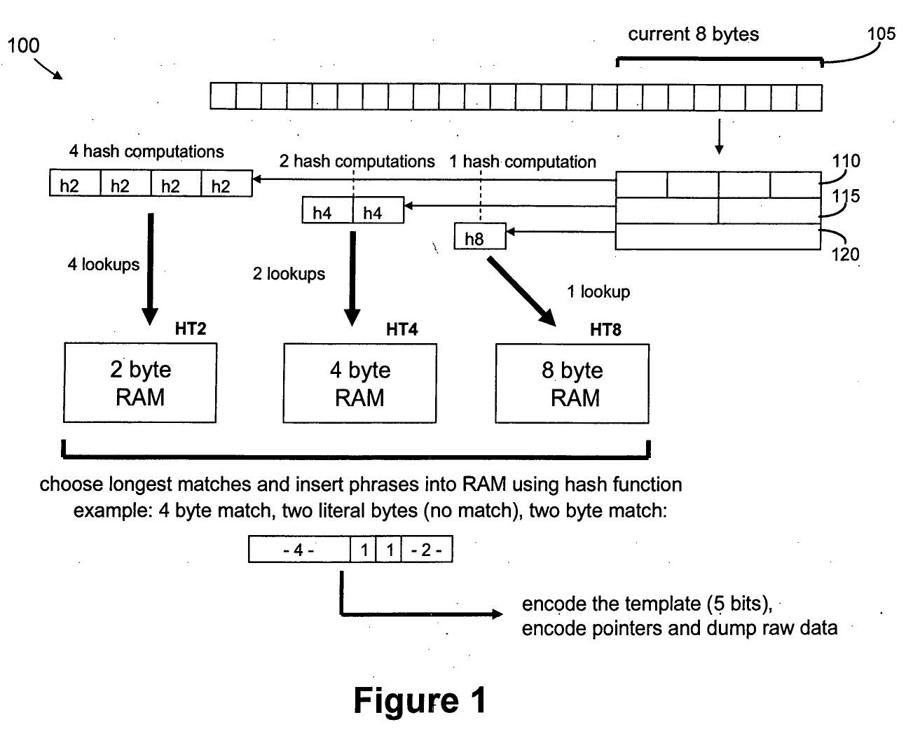

Referring now to FIG. 1, an exemplary low complexity lossless compressor (i.e., encoder) (100) is shown, in accordance with one embodiment of the present invention. A data stream is segmented into 8-byte blocks (105), each of which are successively processed. Further, separate dictionaries are maintained for phrases (i.e., portions of an 8-byte block) of lengths two (110), four (115) and eight (120) bytes, respectively. Upon acceptance of an 8-byte block (105), an encoder (100) searches the 8-byte dictionary (not shown) for a match of the current 8-byte block (105). In parallel, the encoder searches the 4-byte dictionary (not shown) for a match to the two 4-byte subblocks (115) obtained by halving the 8-byte block (105). Finally, also in parallel, the encoder (100) searches for a match for the four 2-byte subblocks (110) formed by dividing the 8-byte block (105) in four, equally-sized subblocks. In summary, the encoder 100 performs in parallel seven searches: one 8 byte, two four byte and four two byte comparisons.

It should be appreciated that the use of 8-byte blocks herein is only exemplary. One skilled in the art would recognize that any of a variety of phrase lengths may be used, as contemplated by those skilled in the art.

The term “dictionary,” as used herein, refers to a logical entity that accepts queries for phrases of a certain fixed length. These fixed-length phrases may be stored in the dictionary. It should be appreciated that such dictionaries may be implemented in any of a variety of forms, such as depending on the desired level of parallelism for the searches. For example, a 2-byte dictionary may be implemented as a four port dictionary (i.e., capable of handling four simultaneous requests). For another example, a 4-byte dictionary may be implemented as a two port dictionary (i.e., capable of handling two simultaneous requests). It should further be appreciated that multiple copies of a dictionary may be provided and maintained, as contemplated by those skilled in the art.

A dictionary may be queried using hash functions. For purposes of this disclosure, a hash function accepts phrases and produces an index associated with the phrase. The index is not expected to be unique for a given phrase. However, it should be appreciated that good hash functions will distribute all phrases as uniformly as possible over the possible range for the indexes. For example, a dictionary may be accessed using a hash index computed from the phrase that is being searched, and may be organized so that the hash index selects a row comprising more than one phrase. Some loss of compression performance may be experienced due to collisions that inevitably result when employing data structures of this sort. Nevertheless, implementation improvement implications can be quite significant versus an alternative dictionary implementation that supports queries through a fully associative mechanism.

The hash functions described herein may be implemented to compress data units of a fixed size. Assuming a fixed size of 512 bytes, the hash functions employed to compress one unit of 512 bytes need not be equal to the hash functions employed to compress a different unit of 512 bytes, as long as both the encoder and decoder have a means to replicate the selection of the hash functions. This feature may be desirable to protect the compression performance from a potentially bad choice of fixed hash functions that could be evidenced when compressing specific kinds of data. Although hash functions are used to query dictionaries in the exemplary embodiments described herein, it should be appreciated that other mechanisms may be used to query dictionaries, as contemplated by those skilled in the art.

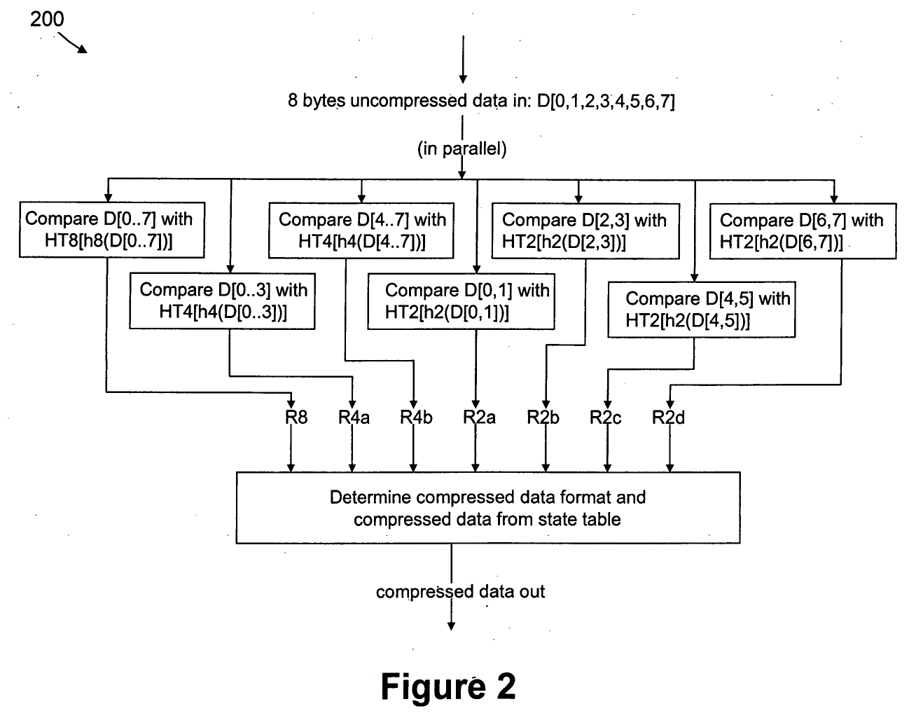

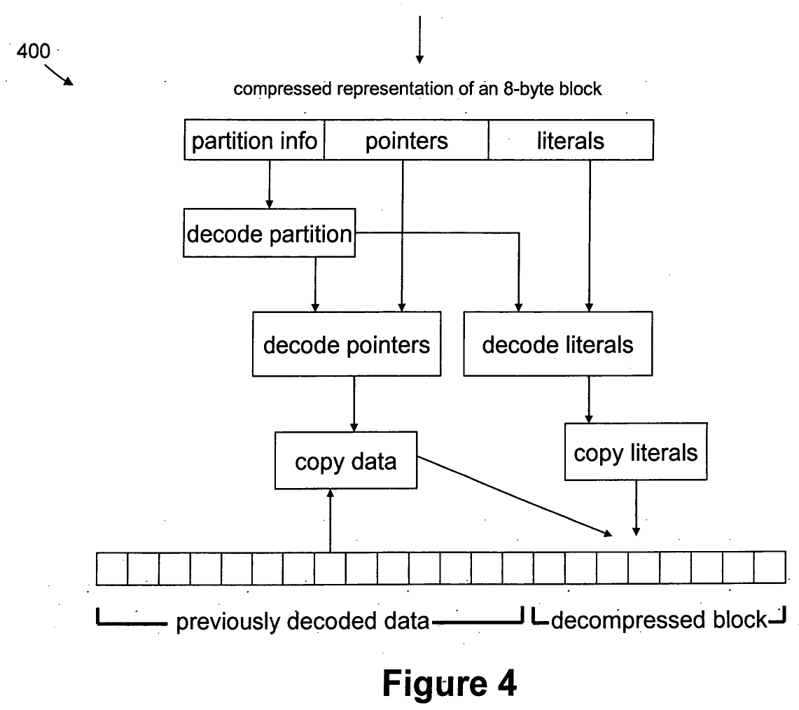

An encoder (as shown in FIGS. 1 and 2) may choose a representation of an 8-byte block or stream that is advantageous for succinct description to a decoder. A decoder (as shown in FIG. 4) takes as input the description, and via simple copies from past decoded data, recovers the encoded 8-byte block.

Referring again to FIG. 1, the encoder (100) searches the 8-byte dictionary for a match of the 8-byte block (120) or stream. If a full 8-byte match is found, a pointer is retrieved from the 8-byte dictionary. In one embodiment, the pointer, as shown in greater detail in FIG. 4, may comprise a previously-stored pointer that points to a location in data that has been previously processed using the same compression method. In an alternate embodiment, the pointer may point to an item in a list. Such indirect methods may allow for compression improvement at a cost of implementation complexity.

If there is no match in the 8-byte dictionary, the encoder (100) searches the 4-byte dictionary for each of the 4-byte subblocks (115). This search may take place in parallel with the 8-byte search. The search may result in three possible outcomes: (1) both 4-byte subblocks have a match in the 4-byte dictionary; (2) exactly one of the 4-byte subblocks has a match; or (3) neither subblock has a match. For every 4-byte subblock that has a match, a pointer is retrieved from the 4-byte dictionary.

Finally, the encoder (100) searches the 2-byte dictionary for each of the 2-byte subblocks (110). This search may take place in parallel with all previously described searches. For every subblock that has a match, a key is retrieved from the 2-byte dictionary.

Although not so limited, it should be appreciated that the preceding method may be implemented in hardware. For example, as previously described the hardware may execute the steps of the method in parallel. That is, in each successive cycle, it is simultaneously determined whether there is an 8-byte match, 4-byte matches, or 2-byte matches. However, it is understood that the method may also be implemented in software, firmware, and the like, as contemplated by those skilled in the art.

The preceding method may further incorporate a run length detection method in order to accomplish the simple compression of repetitive data. For example, assume an encoder has the means to store a previous 8-byte block that was processed in a previous execution of the encoder. Further assume the encoder has a run length counter that, at the beginning of the operation of the encoder, is set to zero. The encoder determines whether a current 8-byte block is equal to the previous 8-byte block. If so, the encoder increments the run length counter and declares the processing of the current 8-byte block as finished. If the current 8-byte block is different from the previous 8-byte block, the encoder checks whether the run length counter is greater than zero. If so, the encoder encodes a run of identical 8-byte phrases of a length as specified by the run length counter and then resumes encoding as previously described.

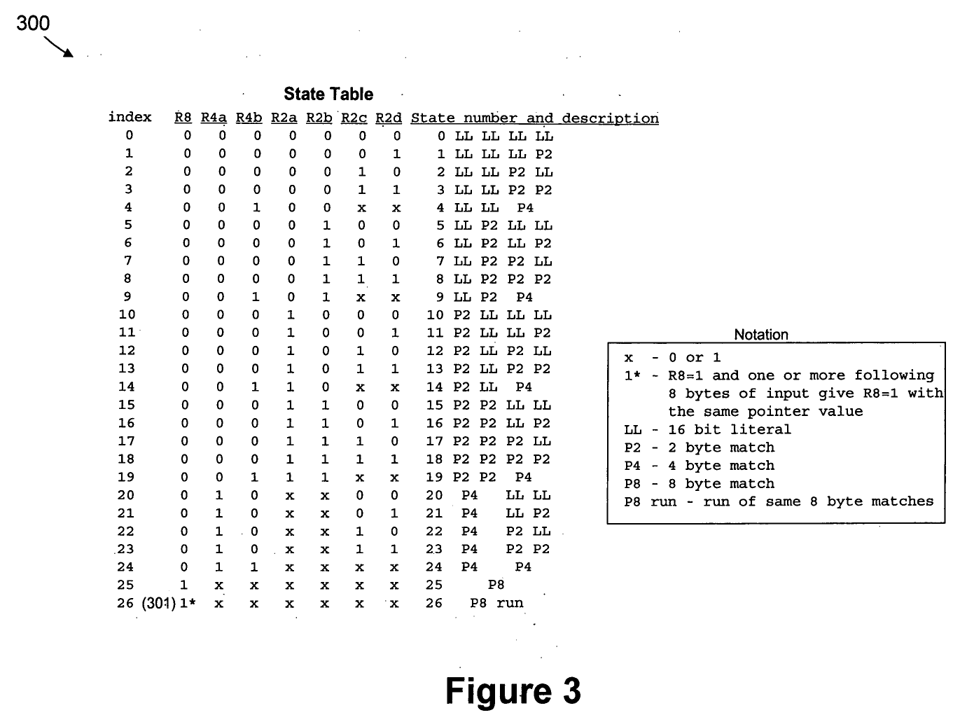

FIG. 3 shows an exemplary outcome (represented in FIG. 3 as a state table) of the actions of the encoder described in greater detail above. The exemplary outcome of FIG. 3 shows 27 possibilities for the results of the seven, previously-described comparisons (i.e., one 8-byte, two 4-byte and four 2-byte) and the run length detection mechanism. These comparisons are labeled in FIG. 3 as “R8” (201) for the 8-byte comparison, “R4a” (202) and “R4b” (203) for the two 4-byte comparisons, and “R2a” (204), “R2b” (205), “R2c” (206) and “R2d” (207) for the four 2-byte comparisons. Additionally, the detection of a run of consecutive identical 8-byte phrases is shown in FIG. 3 as' state 26 (301). The results of the comparisons determine one of 27 states, as shown in FIG. 3. In FIG. 3, a zero indicates a non-equal comparison, a one indicates an equal comparison, and x indicates a don't-care condition. States with a higher index are always chosen in preference to lower numbered states. The 26th state is selected if a run, as previously described, has been detected. The encoder may transmit this state via 5-bit encoding of the index.

The encoder also transmits the pointers for every successful match in the selected state, and encodes all unsuccessful matches (also referred to as “literals”) using a standard representation for such unsuccessful matches, as contemplated by those skilled in the art. For example a 2-byte literal may be encoded using 16 bits. In an exemplary embodiment in which keys are pointers to already encoded data, the pointers may be encoded efficiently if the encoding representation reflects (a) whether the pointers point to 8, 4 or 2-byte phrases, and (b) the maximum possible value for the pointers within the block.

The encoder may ensure that relevant information is stored in the dictionaries by updating the dictionaries on every processing of an 8-byte block. If a row selected by a hash function has a fixed depth greater than one and the row is full, a least recently used (hereinafter “LRU”) phrase replacement strategy can be employed when attempting additions to the dictionary. A state for every row is included for the phrases currently residing in that row. The state may be used for implementing the chosen replacement strategy. It should be appreciated that a multiplicity of strategies known in the art can give acceptable performance, including LRU, random replacement, first-in-first-out (“FIFO”) replacement, and the like.

If there is a match in the 8-byte dictionary, the state of the dictionary may be updated to reflect that the matched 8-byte phrase is the most recently used. If there is no match in the 8-byte dictionary, the phrase may be added to the dictionary, along with a key value that corresponds to the index of the current 8-byte block being processed. This method may also be applied to the 4-byte dictionary using the two 4-byte phrases and the 2-byte dictionary using the four 2-byte phrases.

It should be appreciated that the decoder need not replicate the dictionaries that the encoder is building and be limited to decoding the 5-bit template. The reason is that, in one embodiment, the pointers retrieved from the dictionaries at the encoding process refer to indexes within the already encoded or processed data. As a consequence, the decoder is required to copy only from decoded data whenever a match is found or to simply copy the literals if no match is found. Run lengths are decoded similarly, by copying the last 8-byte phrase the number of times specified by the encoder.

In certain applications, such as very fast compression of memory faster encoding and/or decoding is required for relatively small data units (e.g., 512 bytes). In processing a number P of streams segregated from the 512-byte data unit, for example, a dictionary may be employed that is constructed using all the P streams, as opposed to P independently-maintained dictionaries. The reason for this being that compression performance can be significantly hurt if the number of 8-byte blocks that contribute to the building of a dictionary is not large enough.

The present invention can be adapted easily so that a number P of blocks are processed in parallel with a common dictionary. The parallelism may be attained by increasing the number of simultaneous queries and additions that each dictionary can support. In hardware implementations, parallelism can be accomplished through simple replication or through the use of multiported random access memories (“RAMs”). The descriptions of the P streams, each describing 512/P bytes, can be stored in P storage areas that are mutually disjoint. The P storage areas may be stored in a single common storage area and described by a simple header. This formatting enables faster decoding as it allows P independent decoders to contribute to the reconstruction of the original 512 byte data unit in parallel.

Compression may be improved via additional encoding mechanisms for the pointer values stored and retrieved from the dictionaries. For example, three separate lists for phrase lengths 2, 4 and 8 bytes can be maintained, along with three counters describing how many phrases of each kind have been stored in the lists. A phrase may be added to the list if the phrase is not found in the dictionary. Further, instead of storing in the dictionary a pointer to the current position in the data unit being compressed, the index within the list may be encoded. Using this exemplary method, the decoder needs to replicate the dictionaries as they are built by the encoder in addition to replicating the construction of the lists. This technique is based on the empirical observation that these lists will often have much fewer entries than the number of phrases of the associated length that have been processed. Therefore, an encoding via the list may be more efficient; however, the decoder may be more complex.

In some situations, the alignment of the data being compressed may not be known. This is potentially harmful for a compression device that makes strong alignment-dependent assumptions about the nature of the data. A method has been presented that allows for the selection of an alignment in the basis of its potential for good compression performance. If the phrase lengths are 2, 4 and 8 bytes, the method initially maintains two different dictionaries for the two possible alignments for the 2-byte phrases (i.e., the smallest length). After a prescribed number of additions A₂ to the dictionaries, the dictionary with the best hit rate characteristics is selected, and two different dictionaries for the two remaining alignments for the 4-byte phrases are maintained. After a prescribed number of additions A₄ to the dictionaries, the dictionary with the best hit rate characteristics is selected, and the process is iterated for the two possible remaining alignments for the 8-byte phrases. This idea can be clearly extended if the phrase lengths L₁, L₂ . . . , L_{M} each divide its successor (e.g., L₁ divides L₂, L₂ divides L₃, etc.). The first decision requires the examination of L₁ different alignments. The second decision requires the examination of L₂/L₁ different alignments. The third decision requires L₃/L₂ different alignments and so on.

As described in greater detail above, embodiments of the present invention achieve compression at comparable or better encoding and decoding speeds over the prior art, but with reduced required hardware resources. For example, in one embodiment of the present invention, only one 8-byte comparator, two 4-byte comparators, and four 2-byte comparators are required. Additionally, three random access memories (“RAMs”) may be used. The sizes and configuration of the RAMs may be as follows: one 8-byte wide RAM with 64 entries, one two-ported 4-byte wide RAM with 128 entries, and one four-ported 2-byte wide RAM with 256 entries. This example assumes the unit of compression is a 512 byte block.

It should be appreciated that other sizes and configurations may be used, as contemplated by those skilled in the art. The RAM sizes may be chosen to give acceptable compressibility, as contemplated by those skilled in the art. It is understood that improved compressibility can be achieved by increasing the sizes of the RAMs.

The particular embodiments disclosed above are illustrative only, as the invention may be modified and practiced in different but equivalent manners apparent to those skilled in the art having the benefit of the teachings herein. Furthermore, no limitations are intended to the details of design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed is:

1. A method for compressing a stream of symbols, comprising:
dividing the stream into fixed-length blocks;
for each of the fixed-length blocks, searching entries in a plurality of dictionaries for fixed-length phrases obtained from the each of the fixed-length blocks;
choosing one of a plurality of partitions of the each of the fixed-length blocks based on the results of the step of searching and on a specified plurality of allowed partitions, wherein the one of the plurality of partitions comprises a plurality of non-overlapping component phrases, and wherein a concatenation of the plurality of non-overlapping component phrases comprises the each of the fixed-length blocks; and
for each of the non-overlapping component phrases, obtaining one of a pointer and a literal to represent the each of the non-overlapping component phrases.

2. The method of claim 1, further comprising:
grouping the representations of the plurality of non-overlapping component phrases; and
outputting the group of the representations.

3. The method of claim 2, wherein the step of choosing one of a plurality of partitions comprises choosing one of a plurality of partitions such that the size of the group is minimized.

4. The method of claim 3, wherein the step of choosing one of a plurality of partitions such that the size of the group is minimized comprises choosing one of the plurality of partitions based on a state table.

5. The method of claim 1, further comprising:
for each of the representations in the group, determining whether the each of the representations is one of a literal and a pointer;
if each of the representations is the literal, outputting the literal; and
if the each of the representations is the pointer, using the pointer to retrieve from a data structure the each of the non-overlapping component phrases, and outputting the each of the non-overlapping component phrases.

6. The method of claim 1, wherein the step of dividing the stream into fixed-length blocks comprises dividing the stream into 8-byte blocks.

7. The method of claim 1, wherein the step of searching entries in a plurality of dictionaries for fixed-length phrases comprises searching entries in a 2-byte dictionary, a 4-byte dictionary, and an 8-byte dictionary for 2-byte phrases, 4-byte phrases, and 8-byte phrases, respectively.

8. The method of claim 1, wherein the step of searching entries in a plurality of dictionaries for fixed-length phrases obtained from the each of the fixed-length blocks comprises searching entries in the plurality of dictionaries in parallel.

9. The method of claim 1, wherein the step of searching entries in a plurality of dictionaries for fixed-length phrases obtained from the each of the fixed-length blocks comprises:
computing a hash index for each of the fixed-length phrases to be searched using a hash function; and
using the hash index for the each of the fixed-length phrases to restrict the number of the entries to be searched.

10. The method of claim 1, wherein searching entries in a plurality of dictionaries for fixed-length phrases obtained from the each of the fixed-length blocks comprises retrieving pointers from the plurality of dictionaries, wherein each of the pointers selects previously processed data.

11. The method of claim 10, wherein the each of the pointers selects previously processed data comprises the each of the pointers selects one of the entries in the plurality of dictionaries.

12. The method of claim 10, wherein the each of the pointers selects previously processed data comprises the each of the pointers selects a phrase in a list.

13. The method of claim 12, wherein a new fixed-length phrase is added to the list if the new fixed-length phrase is absent in one of the plurality of dictionaries corresponding to the new fixed-length phrase.

14. The method of claim 1, further comprising using a run length counter for compressing repetitions of the fixed-length blocks.

15. The method of claim 14, wherein the step of using a run length counter for compressing repetitive data comprises:
incrementing the run length counter, if a current one of the fixed-length blocks is equal to a previous one of the fixed-length blocks; and
encoding a run of identical fixed-length blocks of a length specified by the run length counter, if the current one of the fixed-length blocks is different from the previous one of the fixed-length blocks, and if the run length counter is greater than zero.

16. The method of claim 1, further comprising:
updating the plurality of dictionaries to reflect one of the fixed-length phrases, if the one of the fixed-length phrases is found in the plurality of dictionaries; and
adding the one of the fixed-length phrases to the plurality of dictionaries, if the one of the fixed-length phrases is absent in the plurality of dictionaries.

17. The method of claim 1, wherein the steps of the method are implemented in hardware for execution by a processor.

18. The method of claim 1, wherein the steps of the method are implemented as instructions on a machine-readable medium for execution by a processor.

19. A method for compressing a stream of symbols in parallel, comprising:
dividing the stream into collections of fixed-length blocks, wherein each item in the collections comprises one fixed-length block;
for the each item, searching in parallel entries in a plurality of dictionaries for fixed-length phrases obtained from the each item;
for the each item, choosing one of a plurality of partitions based on (a) the results of the step of searching and (b) on a specified plurality of allowed partitions, wherein the one of the plurality of partitions comprises a plurality of non-overlapping component phrases, and wherein a concatenation of the plurality of non-overlapping component phrases comprises the each item; and
for the each item and for each component phrase of the one of the plurality of partitions, obtaining one of a pointer and a literal to represent the each component phrase.

20. The method of claim 19, further comprising:
grouping in order the representations of the plurality of non-overlapping component phrases of the each item in the collections; and
outputting the group of the representations.

21. The method of claim 19, further comprising:
for each of the representations of the each component phrase in the each item in the collections in parallel, determining whether the each of the representations is one of a literal and a pointer;
if the representation is the literal, outputting the literal; and
if the representation is the pointer, using the pointer to retrieve from a data structure the each component phrase, and outputting the each component phrase.

22. The method of claim 19, wherein the steps of the method are implemented in hardware for execution by a processor.

23. The method of claim 19, wherein the steps of the method are implemented as instructions on a machine-readable medium for execution by a processor.

24. A method for hierarchically aligning a stream of symbols in which the length of phrases of smaller length divide the length of phrases of longer length, comprising:
for a given length, the given length comprising each incrementally longer length starting from the smallest length, (a) maintaining separate dictionaries for different alignments associated with the given length; (b) counting the number of times a phrase is not found in each of the dictionaries and (c) choosing one of the different alignments based on the result of the step of counting.

25. The method of claim 24, wherein the step of choosing comprises choosing one of the different alignments associated with one of the dictionaries with the highest count.

26. The method of claim 24, wherein the steps of the method are implemented in hardware for execution by a processor.

27. The method of claim 24, wherein the steps of the method are implemented as instructions on a machine-readable medium for execution by a processor.

28. In a system comprising a hierarchical data structure, wherein the hierarchical data structure comprises a first dictionary and a second dictionary, wherein the first dictionary comprises at least one first phrase of a first fixed-length, wherein the second dictionary comprises at least one second phrase of a second fixed-length differing from the first phrase length, wherein each of the at least one first phrase and at least one second, phrase is associated with a unique hash key, a method for compressing a block of data using the dictionary, comprising:
(a) segmenting the block into first plurality of subblocks, wherein the size of each of the first plurality of subblocks is the first fixed-length;
(b) segmenting the block into a second plurality of subblocks, wherein the size of each of the second plurality of subblocks is the second fixed-length;
(c) querying the first dictionary for each of the first plurality of subblocks to find a at least one first match;
(d) querying the second dictionary for each of the second plurality of subblocks to find at least one second match;
(e) if at least one of the first match is found in the dictionary, encoding the first match using a first unique pointer associated with the at least one first match; and
(f) if at least one of the second match is found in the dictionary, encoding the at least one second match using a second unique pointer associated with the at least one second match.

29. The method of claim 28, wherein the steps of the method are implemented in hardware for execution by a processor.

30. The method of claim 28, wherein the steps of the method are implemented as instructions on a machine-readable medium for execution by a processor.
